(19) United States
(12) Patent Application Publication
(10) Pub. No.: US 2017/0184080 A1
(43) Pub. Date: Jun. 29, 2017

(54) SHOE FOR HYDRAULIC ROTARY DEVICE, AND HYDRAULIC ROTARY DEVICE

(71) Applicant: KAWASAKI JUKOGYO KABUSHIKI KAISHA, Kobe-shi, Hyogo (JP)

(72) Inventors: Hideki TAMASHIMA, Himeji-shi (JP); Ryo NOMURA, Kobe-shi (JP)

(73) Assignee: KAWASAKI JUKOGYO KABUSHIKI KAISHA, Kobe-shi, Hyogo (JP)

(21) Appl. No.: 15/118,220

(22) PCT Filed: Jan. 5, 2015
(86) PCT No.: PCT/JP2015/050057

§ 371 Date: Aug. 11, 2016

(30) Foreign Application Priority Data
Feb. 12, 2014 (JP) 2014-024761

(51) Int. Cl. F04B 1/12; F04B 53/18; F03C 1/06; F04B 1/20

(52) U.S. Cl. CPC F04B 1/126; F04B 1/20; F04B 53/18; F03C 1/0668

(57) ABSTRACT

A sliding end part of a shoe has an annular seal part located to surround one opening of a lubricant supply hole and sliding on a slide-receiving surface. The sliding end part has a first pad part that has a height from a reference surface lower than the seal part, that is located on the same circumference to partially surround the opening, and that faces the seal part in a radial direction via an annular groove present on an inner side in the radial direction of the seal part. The sliding end part has a second pad part that has a height from the reference surface lower than the seal part, that is located on the same circumference to partially surround the opening, and that faces the seal part in the radial direction via an annular groove present on an outer side in the radial direction of the seal part.

### TECHNICAL FIELD

The present invention relates to a shoe for a hydraulic rotary device having a piston rotating around a rotary shaft to act as a pump or a motor related to a hydraulic pressure of a hydraulic liquid. For example, the present invention relates to a shoe for a swashplate type piston pump motor with a fixed swashplate, a swashplate type piston pump motor with a tilted swashplate, etc.

The present invention also relates to a hydraulic rotary device having a piston rotating around a rotary shaft to act as a pump or a motor related to a hydraulic pressure of a hydraulic liquid. For example, the present invention relates to a swashplate type piston pump motor with a fixed swashplate, a swashplate type piston pump motor with a tilted swashplate, etc.

### BACKGROUND ART

Conventional hydraulic rotary devices include a swashplate type axial machine described in JP 11-218072 A (Patent Document 1). This swashplate type axial machine includes a swashplate and a shoe sliding on a sliding surface of the swashplate. The shoe has a piston mounting part, an annular sliding end part, and an oil supply passage. The sliding end part has a seal part sliding on the sliding surface. The oil supply passage allows communication between a mounting surface of the piston mounting part and an end surface of the sliding end part.

An oil nozzle of the lubricant supply hole is opened at the center of the end surface of the sliding end part. The end surface is formed into a tapered shape with an axial distance from the oil nozzle made larger toward a radially outer side in an axial cross section. A gap between the shoe and the sliding surface of the swashplate is made larger in this way to reduce the friction between the shoe and the sliding surface of the swashplate, so as to suppress a seizure while ensuring a smooth slide of the shoe to reduce a mechanical loss.

However, since the conventional swashplate type axial machine has the end surface formed into the tapered shape described above to make the gap between the shoe and the sliding surface of the swashplate larger, an amount of hydraulic oil leaking between the shoe and the sliding surface of the swashplate becomes large and results in a problem of a large volumetric loss (leakage loss).

Additionally, since the conventional swashplate type axial machine has the end surface formed into a tapered shape with an axial distance from the opening made larger toward the radially outer side in an axial cross section, the gap between the shoe and the sliding surface of the swashplate becomes particularly large in the vicinity of the oil nozzle. Therefore, the oil pressure of the hydraulic oil becomes lower in the vicinity of the oil nozzle and facilitates the generation of cavitation, and damage is easily generated.

On the other hand, if the gap between the shoe and the sliding surface of the swashplate is made smaller so as to avoid the problem of the volumetric loss (leakage loss) of the conventional swashplate type axial machine, the friction between the shoe and the sliding surface of the swashplate becomes larger, resulting in a seizure between the shoe and the swashplate, or the shoe becomes less slidable on the swashplate, resulting in a larger mechanical loss.

### Patent Document

Patent Document 1: JP 11-218072 A (FIG. 3)

### SUMMARY OF THE INVENTION

### Problem to be Solved by the Invention

Therefore, a problem to be solved by the present invention is to provide a shoe for a hydraulic rotary device, and a hydraulic rotary device, capable of reducing a seizure and a mechanical loss and capable of reducing a volumetric loss.

Particularly, in an embodiment, a problem to be solved by the present invention is to provide a shoe for a hydraulic rotary device, and a hydraulic rotary device, capable of suppressing damage due to generation of cavitation.

### Means for Solving Problem

To solve the problem, a shoe for a hydraulic rotary device of the present invention comprises

a piston mounting part for attaching a piston;

a sliding end part having a portion sliding on a slide-receiving surface; and

a lubricant supply hole allowing communication between a mounting surface of the piston mounting part and an end surface of the sliding end part,

the sliding end part having

a substantially planar reference surface,

an annular seal part protruding from the reference surface and located to surround an opening of the lubricant supply hole, the annular seal part sliding on the slide-receiving surface,

a first pad part protruding from the reference surface to a height in an axial direction from the reference surface lower than a height in the axial direction of the seal part from the reference surface, the first pad part being located on the same circumference to entirely or partially surround the opening and facing an inner side surface of the seal part via an annular groove present on an inner side in a radial direction of the seal part, and

a second pad part protruding from the reference surface to a height in the axial direction from the reference surface lower than the height of the seal part, the second pad part being located on the same circumference to entirely or partially surround the opening and facing an outer side surface of the seal part via an annular groove present on an outer side in the radial direction of the seal part.

If the first and second pad parts are annular, the phrase “on the same circumference” is satisfied when the first and second pad parts include at least one circle surrounding the opening. If the first and second pad parts are non-annular, the phrase is satisfied when portions of the first and second pad parts (the first and second pad parts may be each made up of only one non-annular portion or two or more portions) each include a circular arc extending from one circumferential end to the other circumferential end of the portion and at least one circle exists such that the circular arc of the portion is located on the same circle. The requirement of the height in the axial direction of the first pad part from the reference surface being lower than the height in the axial direction of the seal part from the reference surface is satisfied when the maximum height in the axial direction of the first pad part from the reference surface is equal to or less than the height in the axial direction of the seal part from the reference surface and the average height in the axial direction of the first pad part from the reference surface is lower than the height in the axial direction of the seal part from the reference surface. The requirement of the height in the axial direction of the second pad part from the reference surface being lower than the height in the axial direction of the seal part from the reference surface is satisfied when the maximum height in the axial direction of the second pad part from the reference surface is equal to or less than the height in the axial direction of the seal part from the reference surface and the average height in the axial direction of the second pad part from the reference surface is lower than the height in the axial direction of the seal part from the reference surface.

According to the present invention, since the seal part sliding on the slide-receiving surface is annular, and the seal part protrudes further on the side opposite to the piston mounting part in the axial direction as compared to the first pad part and the second pad part, the seal part can be brought into close contact with the slide-receiving surface over the whole circumference. Therefore, an excessive leakage of lubricant can be suppressed by the seal part and the slide-receiving surface, and the hydraulic oil can be enclosed so as to suppress a volumetric loss (a leakage loss of the lubricant).

According to the present invention, the first and second pad parts protruding from the reference surface on the outside and the inside in the radial direction of the seal part to face the seal part via the annular grooves are located on the piston mounting part side in the axial direction relative to the leading end of the seal part. Therefore, the lubricant more easily passes through between the first/second pad parts and the slide-receiving surface so that the flow of the lubricant to the outer side in the radial direction can be facilitated. Therefore, since a frictional force can be reduced, a seizure of a sliding part can be suppressed and a mechanical loss can be suppressed.

In a conventional configuration, the heights of lands are made uniform due to reasons such as easiness of processing; however, this configuration may lead to excessive friction and may result in the seizure. Additionally, in this configuration with lands having uniform height, the excessive friction makes a machine difficult to operate, and a mechanical loss may become larger.

According to the present invention, the first and second pad parts are located radially outside and inside of the seal part on the piston mounting part side in the axial direction relative to the leading end of the seal part and protrude from the reference surface. Therefore, if the shoe deforms toward the slide-receiving surface such as when the shoe is strongly pressed toward the slide-receiving surface, the first and second pad parts can receive a surface pressure. Thus, the behavior of the shoe can be stabilized.

According to the present invention, the first pad part is located radially inside of the seal part and the second pad part is located radially outside of the seal part. Therefore, the first and second pad parts can more uniformly receive the surface pressure in a well-balanced manner in the radial direction on the inside and outside in the radial direction of the seal part. Therefore, the behavior of the shoe can further be stabilized.

In an embodiment,

the sliding end part has at least one of a first lubricant outflow groove crossing through the first pad part in the radial direction and allowing lubricant to outflow to the outer side in the radial direction and a second lubricant outflow groove crossing through the second pad part in the radial direction and allowing lubricant to outflow to the outer side in the radial direction.

According to the first embodiment, if the first lubricant outflow groove crossing through the first pad part in the radial direction is included, the lubricant can be released radially outward through the first lubricant outflow groove. Therefore, the excessive friction can further be prevented from occurring between the first pad part and the slide-receiving surface, and the mechanical loss can further be suppressed. If the second lubricant outflow groove crossing through the second pad part in the radial direction is included, the lubricant can be released radially outward through the second lubricant outflow groove. Therefore, the excessive friction can further be prevented from occurring between the second pad part and the sliding surface, and the mechanical loss can further be suppressed.

In an embodiment,

In a cross section in the axial direction passing through the first pad part, an inner end part of a leading end surface of the first pad part is a tapered surface with a height in the axial direction from the reference surface made lower toward an inner side.

It is noted that the “inner end part” has the same meaning as an end part on the side of the opening.

As described later, the present inventors found from a simulation of a contact surface pressure that a large contact surface pressure is applied to the inner end part of the leading end surface of the first pad part (the end part of the leading end surface of the first pad part on the side of the opening of the lubricant supply hole).

According to the embodiment, since the inner end part of the first pad part is a tapered surface with the height in the axial direction from the reference surface made lower toward the inner side in the cross section, a large contact surface pressure can be prevented from being locally applied to the inner side of the first pad part. Therefore, the seizure and the mechanical loss can be suppressed.

In an embodiment,

In a cross section in the axial direction passing through the second pad part, an outer end part of a leading end surface of the second pad part is a tapered surface with a height in the axial direction from the reference surface made lower toward an outer side.

It is noted that the “outer end part” has the same meaning as an end part on the side opposite to the opening.

From the result of simulation described later, it is considered that if the shoe passes through a low pressure region or is in a region with a larger centrifugal force, the outside in the radial direction is put into a lifted state.

According to the embodiment, since the outer end part of the second pad part is a tapered surface with the height in the axial direction from the reference surface made lower toward the outer side in a cross section, a degree of freedom of vertical motion in the axial direction is increased in the sliding end part of the shoe. Therefore, the outer end part of the second pad part can more smoothly be guided on the slide-receiving surface particularly in a region in which the outer side (the side opposite to the opening of the lubricant supply hole) is put into a lifted state. Therefore, an excessive force can pre prevented from being locally applied to the shoe, and the seal part can more certainly be protected.

In an embodiment,

the sliding end part has a cavitation suppression part that protrudes from the reference surface to a height in the axial direction from the reference surface lower than the height of the seal part, that is located on the same circumference to entirely surround the opening, and that faces an inner side surface of the first pad part via an annular groove present on an inner side of the first pad part.

According to the embodiment, since the cavitation suppression part having the height lower than that of the seal part is present in a region closer to the opening on the inner side relative to the first pad part, a space around the opening can be reduced to suppress the generation of low pressure easily generated around the opening. Therefore, the generation of cavitation can be suppressed and the damage can be suppressed.

A hydraulic rotary device of the present invention comprises the shoe for a hydraulic rotary device of the present invention.

According to the present invention, the seizure and the mechanical loss can be reduced, and the volumetric loss can be reduced.

### Effect of the Invention

The present invention can achieve the shoe for a hydraulic rotary device, and the hydraulic rotary device, capable of reducing the seizure and the mechanical loss and capable of reducing the volumetric loss.

### BRIEF DESCRIPTION OF DRAWINGS

FIG. 1 is a schematic cross-sectional view of a swashplate type piston pump motor of a first embodiment of the present invention.

FIG. 2 is a schematic cross-sectional view of a shoe and a portion of a piston in an axial direction of the shoe.

FIG. 3 is a plane view of an end surface of a sliding end part of the shoe viewed from the outer side in the axial direction.

FIG. 4 is a portion of a schematic cross-sectional view in the axial direction of the shoe and is a schematic cross-sectional view of a periphery of a seal part, a first pad part, and a second pad part.

FIG. 5 is a view of a modification example of the first embodiment corresponding to FIG. 3.

FIG. 6 is a schematic cross-sectional view of a shoe of a second embodiment corresponding to FIG. 4.

FIG. 7 is a portion of a schematic cross-sectional view in the axial direction of a shoe showing a profile of a sliding end part of the shoe of a reference example and is a schematic cross-sectional view of unevenness of the sliding end part in the radial direction from a center to an outer end in the radial direction.

FIG. 8 is a diagram of a relationship between a radial position and a contact surface pressure from a simulation related to the shoe shown in FIG. 7.

FIG. 9 is a portion of a schematic cross-sectional view in the axial direction of a shoe of a third embodiment and is a portion of a schematic cross-sectional view showing a vicinity of an opening of a lubricant supply hole of a sliding end part.

FIG. 10 is a schematic cross-sectional view in the axial direction of a shoe of a further embodiment.

### EMBODIMENTS FOR CARRYING OUT THE INVENTION

The present invention will now be described in detail with reference to shown forms.

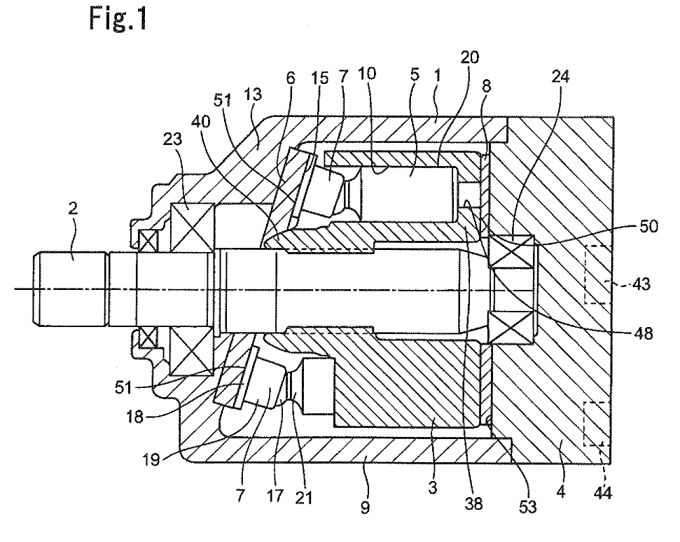

FIG. 1 is a schematic cross-sectional view of a swashplate type piston pump motor of a first embodiment of the present invention.

As shown in FIG. 1, this swashplate type piston pump motor (hereinafter simply referred to as a pump motor) includes a housing 1, an output shaft 2, a cylinder block 3, a plurality of pistons 5, an annular swashplate 6, shoes 7, and a valve plate 8. The housing 1 has a cylindrical main body part 9 and a cover 4. The cylinder block 3 is housed in the main body part 9, and the cover 4 closes an opening on one axial side of the main body part 9.

The cylinder block 3 is coaxially coupled to the output shaft 2. The output shaft 2 is pivotally supported by bearings 23, 24 with respect to the housing 1. The cylinder block 3 is spline-coupled to the output shaft 2. The cylinder block 3 is coupled to the output shaft 2 such that a relative displacement is prevented in the circumferential direction of the output shaft 2. The cylinder block 3 has a plurality of piston chambers 10. The piston chambers 10 extend in the axial direction of the output shaft 2. The multiple piston chambers 10 are located at intervals from each other in the circumferential direction of the output shaft 2. Each of the piston chambers 10 has one axial side opened in the axis direction and the other axial side closed by the other end wall 38 of the cylinder block 3.

The swashplate 6 is fixed to a front wall 13 of the housing 1. The swashplate 6 is inclined relative to a plane perpendicular to the central axis of the output shaft 2. The swashplate 6 is disposed to extend to the upper side of FIG. 1 with inclination to the right. A surface of the swashplate 6 on the cylinder block 3 side is a sliding surface 15 acting as a slide-receiving surface. The swashplate 6 may be configured to have a nonadjustable inclination angle, or may have an inclination angle adjustable with a known inclination angle adjustment mechanism, or may be tiltable.

Each of the shoes 7 is made up of a disk-shaped sliding end part 18 and a columnar sphere mounting part 19 formed integrally. An end surface 51 of the shoe 7 on the swashplate 6 side in the axial direction slidably abuts on the sliding surface 15 of the swashplate 6. The sphere mounting part 19 has a spherical mounting recess. This mounting recess part forms a piston mounting part. Each of the pistons 5 has a sphere part 17 at a leading end on the swashplate 6 side. This sphere part 17 is pivotally mounted on the spherical mounting recess of the sphere mounting part 19. The piston 5 has a substantially columnar fitting part 20 and a connecting part 21. The fitting part 20 is connected via the connecting part 21 to the sphere part 17. The fitting part 20 has an outer circumferential surface fitted into an inner circumferential surface of the piston chamber 10 such that the fitting part 20 can axially advance and retract.

In the piston chamber 10, a portion located on one side in the axial direction of the piston chamber 10 relative to the piston 5 acts as a pressure chamber. This pressure chamber is present on the other end wall 38 side in the axial direction of the piston chamber 10. The cylinder block 3 has valve plate connection holes 48 communicable with the pressure chambers. Each of the valve plate connection holes 48 axially penetrates the cylinder block 3 between the pressure chamber of the piston chamber 10 and an end surface 50 of the cylinder block 3 on the side opposite to the swashplate 6 in the axial direction.

The valve plate 8 is disposed between the end surface 50 of the cylinder block 3 and an end surface 53 of the cover 4 on the cylinder block 3 side in the axial direction. The valve plate 8 is fixed to the cover 4 by a well-known fastening member such as a pin not shown. The end surface 50 of the cylinder block 3 is in sliding contact with the valve plate 8.

When a hydraulic oil is supplied from a hydraulic oil supply port 43 formed on the cover 4, the hydraulic oil is supplied through a supply hole present in a certain phase in the valve plate 8 to the piston chambers 10 of the cylinder block 3 located on the near side relative to the plane of FIG. 1. Accordingly, the piston 5 stretches to press the shoe 7 toward the swashplate 6. Since the swashplate 6 is disposed to extend to the lower side with inclination to the left as shown in FIG. 1, a force acts downward on the shoe 7 pressed against the swashplate 6 by the piston 5. Therefore, the piston 5 located on the near side in FIG. 1 is displaced downward while stretching, and thus, the cylinder block 3 and the output shaft 2 coupled to the cylinder block 3 are driven to rotate clockwise when viewed from the left of FIG. 1.

The pistons 5 located on the far side relative to the plane of FIG. 1 are retracted by receiving a force from the swashplate 6 while moving upward in accordance with the rotation of the cylinder block 3. As a result, the hydraulic oil in the piston chamber 10 is discharged from a discharge hole of the valve plate 8 and a hydraulic oil discharge port 44 of the cover 4 to the outside. The output shaft 2 is rotationally driven in this way.

Additionally, this swashplate type piston pump motor can reversely be operated by a rotary power of the output shaft as compared to the above operation and can convert the rotary power of the output shaft into a flow of the hydraulic oil. Therefore, this swashplate type piston pump motor can suck the hydraulic oil into the piston chambers 10 and can discharge the hydraulic oil from inside the piston chambers 10. Alternatively, this swashplate type piston pump motor can perform a series of operations in which the hydraulic oil is supplied into the piston chamber 10 and the hydraulic oil is discharged from inside the piston chamber 10. Therefore, this swashplate type piston pump motor can be operated as a pump or a motor.

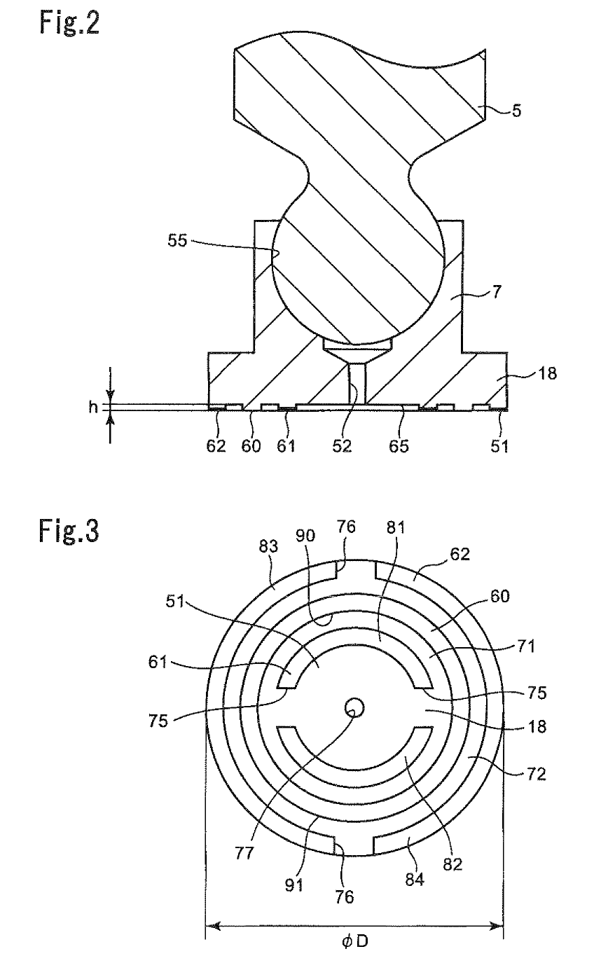

A portion of the hydraulic oil supplied from the supply hole of the valve plate 8 into the piston chamber 10 of the cylinder block 3 is supplied through an oil hole formed in the piston 5 and a lubricant supply hole (denoted by 52 in FIG. 2) of the shoe 7 into between the end surface 51 of the shoe 7 and the sliding surface 15 of the swashplate 6. In this way, the hydraulic oil is used as a lubricant lubricating the end surface 51 of the shoe 7 and the sliding surface 15 of the swashplate 6.

Although not described in detail, the shoes 7 are mounted on an annular keep plate not shown. Additionally, a retainer 40 protruding toward the front wall 13 of the housing 1 is formed on an inner circumferential part of the cylinder block 3. The retainer 40 acts as a plate spring supporting part. An annular plate spring not shown is interposed between this retainer 40 and the keep plate. This plate spring serves to restrain the shoes 7 from lifting.

FIG. 2 is schematic cross-sectional view of the shoe 7 and a portion of the piston 5 in the axial direction of the shoe 7,

As described above, the shoe 7 has a mounting recess part 55 as a piston mounting part, the end surface 51, and the lubricant supply hole 52. As shown in FIG. 2, the mounting recess part 55 is made up of a substantially circular surface in a cross section in the axial direction of the shoe 7. The mounting recess part 55 opens only on one axial side. The axial direction of the shoe 7 is identical to an extension direction of the central axis of the lubricant supply hole 52.

The end surface 51 is made up of an end surface on the side opposite to the mounting recess part 55 in the axial direction of the shoe 7. As shown in FIG. 2, the sliding end part 18 has unevenness on the side opposite to the mounting recess part 55 in the axial direction. Specifically, the sliding end part 18 has an annular seal part 60, a first pad part 61, a second pad part 62, and a reference surface 65 on the side opposite to the mounting recess part 55 in the axial direction. The reference surface 65 is made up of a substantially plane surface. The seal part 60, the first pad part 61, and the second pad part 62 are protruded from the reference surface 65 in a normal direction of the reference surface 65 (this normal direction is identical to the axial direction of the shoe 7). The first pad part 61 is located radially inside of the seal part 60 at a distance from the seal part 60 in a radial direction (the radial direction of the annular seal part 60), and the second pad part 62 is located radially outside of the seal part 60 at a distance from the seal part 60 in the radial direction. It is noted that FIG. 2 shows the unevenness of the sliding end part 18 in an exaggerated manner for easy understanding.

The lubricant supply hole 52 is a through-hole. The lubricant supply hole 52 extends along the central axis of the shoe 7. The axial direction of the shoe 7 is identical to an extension direction of the central axis of the lubricant supply hole 52. The lubricant supply hole 52 allows communication between an end part of a mounting surface of the mounting recess part 55 on the end surface 51 side in the axial direction and the end surface 51. The lubricant supply hole 52 is opened at the center of the end surface 51. The center of the end surface 51 is substantially identical to the opening of the lubricant supply hole 52. A plane is present that passes through the axial center of the lubricant supply hole 52 and that can make the mounting recess part 55 and the lubricant supply hole 52 plane-symmetric. In an example, a distance denoted by h in FIG. 2 between the reference surface 65 and a leading end surface of the seal part 60 can be set to 0.2 to 1.0 mm; however, the distance between the reference surface and the leading end surface of the seal part may be a distance other than 0.2 to 1.0 mm.

FIG. 3 is a plane view of the end surface 51 viewed from the axial outer side.

As shown in FIG. 3, the seal part 60 is an annular protruding part. In the plane view of FIG. 3, an edge on the outer side in the radial direction of the seal part 60 and an edge on the inner side in the radial direction of the seal part 60 are made up of circles substantially around a center of an opening 77 of the lubricant supply hole. The radial direction of the seal part 60 is identical to the radial direction of the shoe 7. It is noted that when terms “radial direction,” “inner side,” and “outer side” are independently used in this description, these terms refer to the radial direction of the shoe 7, the inner side in the radial direction of the shoe 7, and outer side in the radial direction of the shoe 7.

In the plane view shown in FIG. 3, the first pad part 61 is made up of two circular arc portions 81, 82 located at a distance from each other. In the plane view shown in FIG. 3, the two circular arc portions 81, 82 are located on the same circumference around the center of the opening 77 of the lubricant supply hole 52 (see FIG. 2). The sliding end part 18 has two first lubricant outflow grooves 75. The two first lubricant outflow grooves 75 extend on one straight line passing through the center of the opening 77. The first lubricant outflow grooves 75 cross through between the two circular arc portions 81, 82 of the first pad part 61 in the radial direction.

The second pad part 62 is made up of two circular arc portions 83, 84 located at a distance from each other. In the plane view shown in FIG. 3, the two circular arc portions 83, 84 are located on the same circumference around the center of the opening 77. The sliding end part 18 has two second lubricant outflow grooves 76. The two second lubricant outflow grooves 76 extend on one straight line passing through the center of the opening 77. The second lubricant outflow grooves 76 cross through between the two circular arc portions 83, 84 of the second pad part 62 in the radial direction. The first and second lubricant outflow grooves 75, 76 serve to release and allow the hydraulic oil as a lubricant supplied through the opening 77 of the lubricant supply hole 52 to outflow to the outer side in the radial direction.

As shown in FIG. 3, the extension direction of the first lubricant outflow grooves 75 is substantially orthogonal to the extension direction of the second lubricant outflow grooves 76. This causes the hydraulic oil leaking outside through the first lubricant outflow grooves 75 and the second lubricant outflow grooves 76 to go through a wider region on the end surface 51, allowing the shoe 7 to float from the sliding surface 15 due to the oil pressure of the hydraulic oil and making it difficult for the hydraulic oil to leak outside.

As shown in FIG. 3, the first pad part 61 and the second pad part 62 are each present to partially surround the opening 77. The first pad part 61 radially faces an inner side surface 90 of the seal part 60 via an annular groove 71 present on the inner side in the radial direction of the seal part 60. The second pad part 62 radially faces an outer side surface 91 of the seal part 60 via an annular groove 72 present on the outer side in the radial direction of the seal part 60. As shown in FIGS. 2 and 3, the seal part 60, the first pad part 61, the second pad part 62, the annular groove 71, and the annular groove 72 have substantially the same widths in the radial direction. The diameter of the end surface 51 is denoted by φD in FIG. 3 and can be, for example, 15 to 60 [mm]; however, the value of the diameter may obviously be a value other than 15 to 60 [mm].

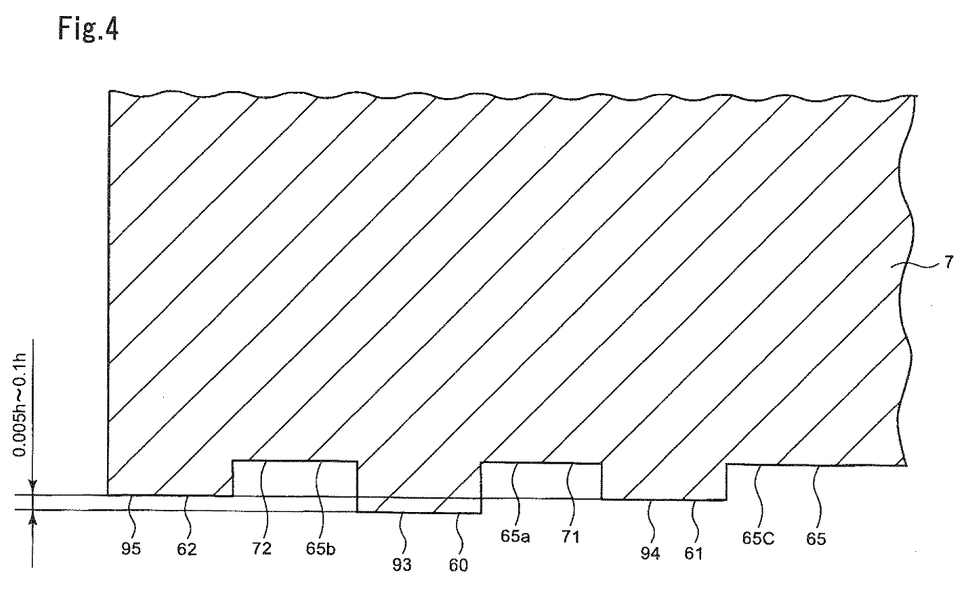

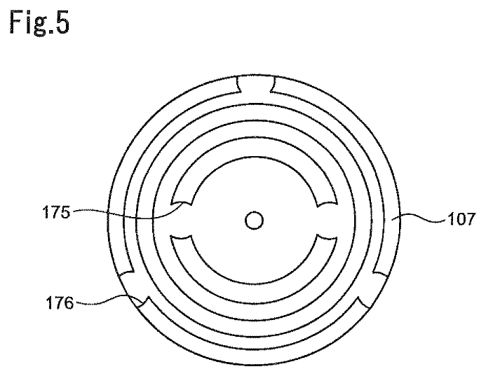

FIG. 4 is a portion of a schematic cross-sectional view in the axial direction of the shoe 7 and is a schematic cross-sectional view of the periphery of the seal part 60, the first pad part 61, and the second pad part 62.

As shown in FIG. 4, the seal part 60, the first pad part 61, and the second pad part 62 each have a substantially rectangular shape in a cross section in the axial direction of the shoe 7. Each of a leading end surface 93 of the seal part 60, a leading end surface 94 of the first pad part 61, a leading end surface 95 of the second pad part 62, and the reference surface 65 is a plane surface. A normal direction of each of the leading end surface 93 of the seal part 60, the leading end surface 94 of the first pad part 61, the leading end surface 95 of the second pad part 62, and the reference surface 65 is substantially identical to the axial direction of the shoe 7. In FIG. 4, a bottom surface 65a of the annular groove 71, a bottom surface 65b of the annular groove 72, and an inner side surface 65c present on the inner side in the radial direction of the first pad part 61 each form a portion of the reference surface 65. The bottom surface 65a, the bottom surface 65b, and the inner side surface 65c are located on the same plane.

As shown in FIG. 4, the height of the seal part 60 from the reference surface 65 is height than the height of the first pad part 61 from the reference surface 65 and is higher than the height of the second pad part 62 from the reference surface 65. The height of the first pad part 61 from the reference surface 65 is substantially identical to the height of the second pad part 62 from the reference surface 65.

As shown in FIG. 4, when h is a distance between the reference surface 65 and the leading end surface 93 of the seal part 60 (the height of the seal part 60 from the reference surface 65), a distance between the leading end surface 93 of the seal part 60 and the leading end surface 94 of the first pad part 61 as well as a distance between the leading end surface 93 of the seal part 60 and the leading end surface 95 of the second pad part 62 can be set to 0.005 h to 0.1 h. However, a ratio of the distance between the leading end surface of the seal part and the leading end surface of the first pad part to the height h of the seal part from the reference surface as well as a ratio of the distance between the leading end surface of the seal part and the leading end surface of the second pad part to the height h of the seal part from the reference surface may obviously be set to other values.

According to the first embodiment, since the seal part 60 sliding on the sliding surface 15 is annular and the seal part 60 protrudes further on the side opposite to the piston mounting part in the axial direction as compared to the first pad part 61 and the second pad part 62, the seal part 60 can be brought into close contact with the sliding surface 15 over the whole circumference. Therefore, an excessive leakage of the hydraulic oil can be suppressed by the seal part 60 and the sliding surface 15, and the hydraulic oil can be enclosed so as to suppress a volumetric loss (a leakage loss of the lubricant).

According to the first embodiment, the first and second pad parts 61, 62 protruding from the reference surface 65 are located radially outside and inside of the seal part 60 to face the seal part 60 via the annular grooves, on the piston mounting part side in the axial direction relative to the leading end of the seal part 60. Therefore, the hydraulic oil more easily passes through between the first/second pad parts 61, 62 and the sliding surface 15 so that the flow of the hydraulic oil to the outer side in the radial direction can be facilitated. Therefore, since a frictional force can be reduced, a seizure of a sliding part can be suppressed and a mechanical loss can be suppressed.

In a conventional configuration, the heights of lands are made uniform due to reasons such as easiness of processing. However, this configuration may lead to excessive friction and may result in the seizure, and since the excessive friction makes a machine difficult to operate, a mechanical loss may become larger.

According to the first embodiment, the first and second pad parts 61, 62 are located radially outside and inside of the seal part 60 on the piston mounting part side in the axial direction relative to the leading end of the seal part 60 and protrude from the reference surface 65. Therefore, if the shoe 7 deforms toward the sliding surface 15 such as when the shoe 7 is strongly pressed toward the sliding surface 15, the first and second pad parts 61, 62 can receive a surface pressure. Thus, the behavior of the shoe 7 can be stabilized.

According to the first embodiment, the first pad part 61 is located radially inside of the seal part 60 and the second pad part 62 is located radially outside of the seal part 60. Therefore, the first and second pad parts 61, 62 can more uniformly receive the surface pressure in a well-balanced manner in the radial direction on the inside and outside in the radial direction of the seal part 60, so that the behavior of the shoe 7 can further be stabilized.

According to the first embodiment, since the first lubricant outflow grooves 75 crossing through the first pad part 61 in the radial direction is included, the hydraulic oil can be released radially outward through the first lubricant outflow grooves 75. Therefore, the excessive friction can further be prevented from occurring between the first pad part 61 and the sliding surface 15, and the mechanical loss can further be suppressed. Since the second lubricant outflow grooves 76 crossing through the second pad part 62 in the radial direction is included, the hydraulic oil can be released radially outward through the second lubricant outflow grooves 76. Therefore, the excessive friction can further be prevented from occurring between the second pad part 62 and the sliding surface 15, and the mechanical loss can further be suppressed.

In the first embodiment, the shoe 7 has the two first lubricant outflow grooves 75 crossing through the first pad part 61 in the radial direction and the two second lubricant outflow grooves 76 crossing through the second pad part 62 in the radial direction. However, in the present invention, the shoe may have either the first lubricant outflow grooves crossing through the first pad part in the radial direction or the second lubricant outflow grooves crossing through the second pad part in the radial direction or may have neither of these grooves. If the shoe has a groove crossing through at least one of the first pad part and the second pad part, the groove may not extend exactly in the radial direction and may extend in any direction as long as the direction has a radial extension component. The shoe may have any number of grooves crossing through the first pad part equal to or greater than one and may have any number of grooves crossing through the second pad part equal to or greater than one. The shoe may have grooves crossing through the first pad part in any phase in the circumferential direction and may have grooves crossing through the second pad part in any phase in the circumferential direction.

In the first embodiment, the first lubricant outflow grooves 75 and the second lubricant outflow grooves 76 have a linear shape. However, in the present invention, at least one of the grooves crossing through the pad parts may have a curved shape etc. other than the linear shape. For example, as shown in FIG. 5, i.e., a view of a shoe of a modification example corresponding to FIG. 3, grooves 175, 176 crossing through the pads of the shoe 107 may have side surfaces formed of concave surfaces.

In the first embodiment, the seal part, the first pad part, the second pad part, the annular groove between the seal part and the first pad part, and the annular groove between the seal part and the second pad part have substantially the same widths in the radial direction. However, in the present invention, at least one of the first pad part, the second pad part, the annular groove between the seal part and the first pad part, and the annular groove between the seal part and the second pad part may have a width in the radial direction different from the other widths. In the present invention, the widths in the radial direction described above may freely be determined based on specifications.

In the present invention, preferably, the shoe is made of a copper alloy or a steel material with the sliding end surface made of copper; however the shoe may be made of any metal material.

In the hydraulic rotary device of the present invention, the number of piston chambers may be an even number or an odd number. Although the piston 5 has the sphere part 17 and the shoe 7 has the sphere mounting part 19 in the first embodiment, the present invention may be configured such that the piston has the sphere mounting part while the shoe has the sphere part. In this way, the hydraulic rotary device of the present invention may be a device acquired by applying any well-known modification to the embodiment.

Although the hydraulic rotary device is a swashplate type pump motor in the first embodiment, the hydraulic rotary device of the present invention may be a swashplate type motor having only the motor function or a swashplate type pump having only the pump function. Alternatively, the hydraulic rotary device of the present invention may be a bent axis type piston pump motor, a bent axis type piston pump, or a bent axis type piston motor. The hydraulic rotary device of the present invention may be any motor having a rotary shaft rotating based on a hydraulic pressure difference of the hydraulic liquid. The hydraulic rotary device of the present invention may be any pump discharging the hydraulic liquid due to rotation of a rotary shaft.

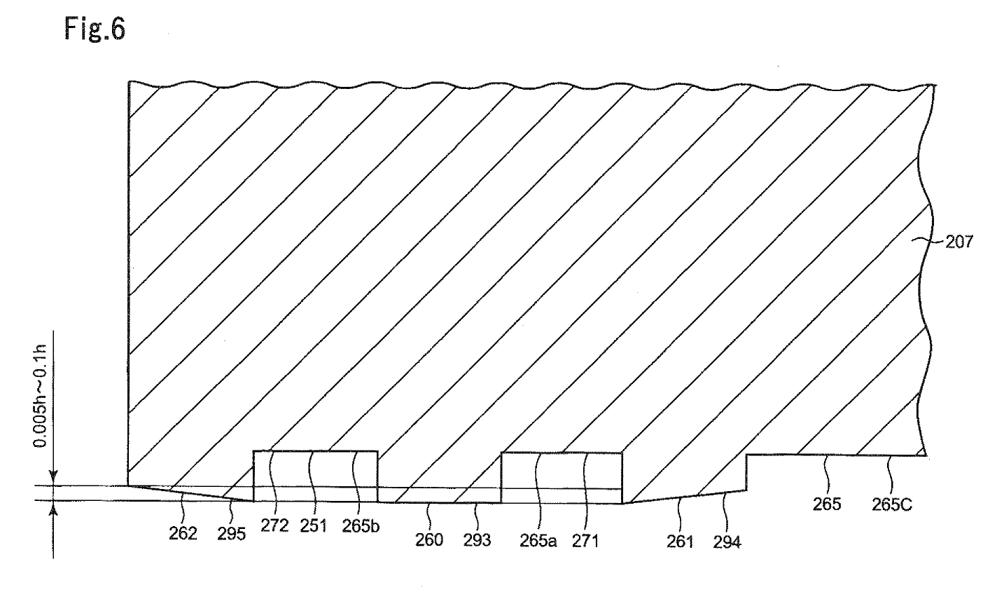

FIG. 6 is a schematic cross-sectional view of a shoe 207 of a second embodiment corresponding to FIG. 4. In the second embodiment, the same actions, effects, and modification examples as the first embodiment will not be described.

As shown in FIG. 6, in the second embodiment, a seal part 260 has a shape substantially identical to that of the first embodiment. However, the second embodiment is different from the first embodiment in that a leading end surface 294 of a first pad part 261 has a shape with an axial distance from a leading end surface 293 of the seal part 260 made longer toward the inner side in the radial direction and that a leading end surface 295 of a second pad part 262 has a shape with a distance from the leading end surface 293 of the seal part 260 made longer toward the outer side in the radial direction. In other words, in a cross section in the axial direction of the shoe 207 passing through the first pad part 261, the leading end surface 294 of the first pad part 261 is a tapered surface with an axial height from a reference surface 265 made lower toward the inner side in the radial direction. In a cross section in the axial direction of the shoe 207 passing through the second pad part 262, the leading end surface 295 of the second pad part 262 is a tapered surface with an axial height from the reference surface 265 made lower toward the outer side in the radial direction.

In FIG. 6, the reference surface 265 and the leading end surface 293 of the seal part 260 is parallel to each other. In FIG. 6, reference numerals 271, 272 denote annular grooves; reference numeral 265a denotes a bottom surface of the annular groove 271; reference numeral 265b denotes a bottom of the annular groove 272; and reference numeral 265c denotes an inner side surface located on the inner side in the redial direction relative to the first pad part 261. The bottom surface 265a of the annular groove 271, the bottom surface 265b of the annular groove 272, and the inner side surface 265c are all located on the same plane. The bottom surface 265a of the annular groove 271, the bottom surface 265b of the annular groove 272, and the inner side surface 265c each form a portion of the reference surface 265.

As shown in FIG. 6, in the second embodiment, a distance from the reference surface 265 to an end of the leading end surface 294 of the first pad part 261 on the outer side in the radial direction is substantially identical to a distance from the reference surface 265 to the seal part 260, and a distance from the reference surface 265 to an end of the leading end surface 295 of the second pad part 262 on the inner side in the radial direction is substantially identical to the distance from reference surface 265 to the seal part 260.

In the second embodiment, when h is a distance between the reference surface 265 and the leading end surface 293 of the seal part 260, for example, a maximum distance between the leading end surface 293 of the seal part 260 and the leading end surface 294 of the first pad part 261 as well as a maximum distance between the leading end surface 293 of the seal part 260 and the leading end surface 295 of the second pad part 262 can be set to 0.005 h to 0.1 h. However, a ratio of the maximum distance between the leading end surface of the seal part and the leading end surface of the first pad part to the distance h between the reference surface and the leading end surface of the seal part may be set to other values. Additionally, a ratio of the maximum distance between the leading end surface of the seal part and the leading end surface of the second pad part to the distance h between the reference surface and the leading end surface of the seal part may be set to other values.

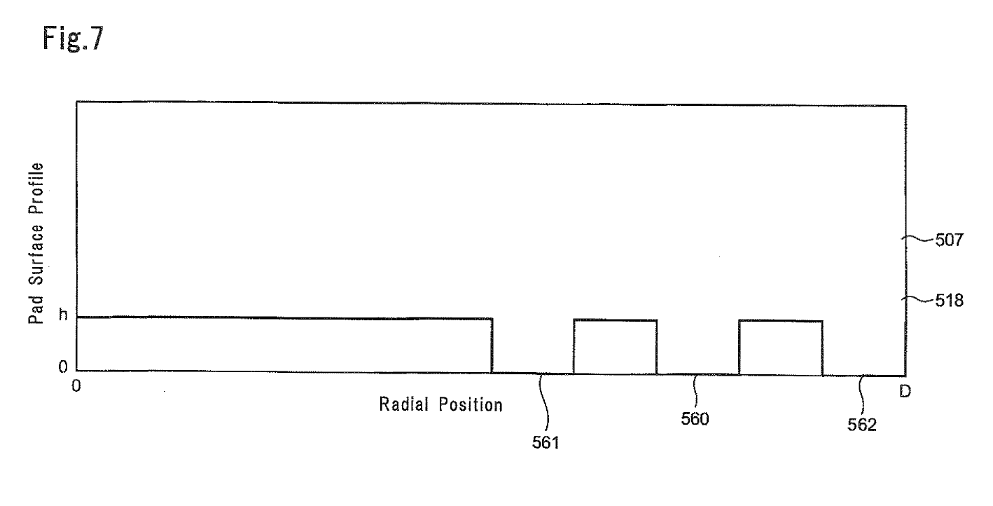

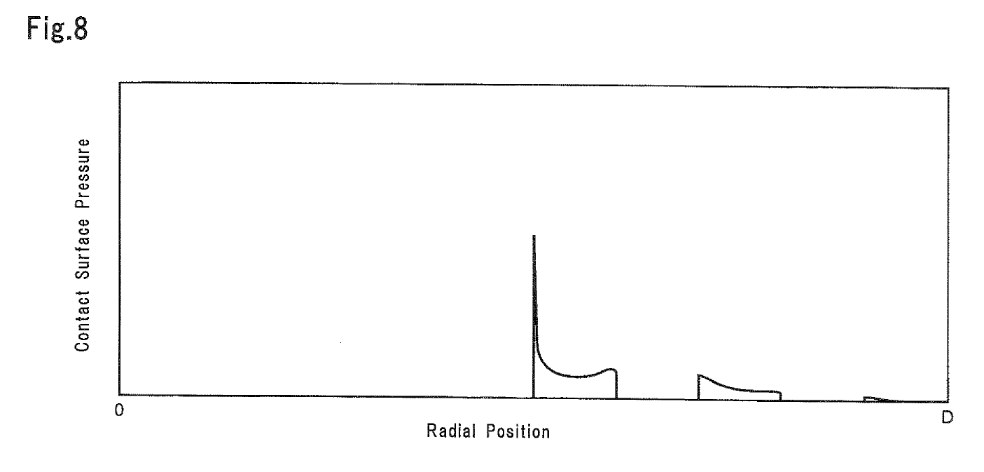

FIG. 7 is a portion of a schematic cross-sectional view in the axial direction of a shoe 507 showing a profile of a sliding end part 518 of the shoe 507 of a reference example and is a schematic cross-sectional view of unevenness of the sliding end part 518 in the radial direction from the center to an outer end in the radial direction. FIG. 8 is a diagram of a relationship between a radial position (a position in the radial direction) and a contact surface pressure from a simulation related to the shoe shown in FIG. 7.

The simulation of FIG. 8 reveals that in the sliding end part 518 of the reference example having a seal part 560 and first and second pad parts 561, 562, an excessive contact surface pressure is applied to an end part on the inner side (the inside in the radial direction) of the first pad part 561. The simulation also reveals that a large contact surface pressure is not applied to an end part on the outer side (the outer side in the radial direction) of the second pad part 562. Therefore, it is considered that if the shoe 507 passes through a low pressure region or is in a region with a larger centrifugal force, the outside in the radial direction of the shoe tends to be lifted.

According to the second embodiment, in a cross section in the axial direction of the shoe 207, the leading end surface 294 of the first pad part 261 is a surface tapered such that a position present on the surface is displaced toward the piston mounting part in the axial direction as the position moves to the inner side, and therefore, a large contact surface pressure can be prevented from being locally applied to the end part on the inner side in the radial direction of the first pad part 261. Therefore, the seizure and the mechanical loss can be suppressed.

According to the second embodiment, in a cross section in the axial direction of the shoe 207, the leading end surface 295 of the second pad part 262 is a surface tapered such that a position present on the surface is displaced toward the piston mounting part in the axial direction as the position moves to the outer side, and therefore, a degree of freedom of vertical motion is increased in the axial direction of the shoe 207. Therefore, an excessive force applied to the seal part 260 can be suppressed particularly in a region in which the outside in the radial direction is put into a lifted state, and the seal part 260 can more certainly be protected. Additionally, in such a region, the end part on the outer side in the radial direction of the second pad part 262 can smoothly be guided on the sliding surface (slide-receiving surface) of the swashplate so that the behavior of the shoe 207 can be stabilized.

In the second embodiment, the leading end surface 294 of the first pad part 261 is entirely the tapered surface. However, in the cross section in the axial direction passing through the first pad part, at least the end part on the inner side (the inner side in the radial direction) of the leading end surface of the first pad part may be a tapered surface with an axial distance from the reference surface made shorter toward the inner side (the inner side in the radial direction), and the leading end surface of the first pad part may not entirely be the tapered surface.

In the second embodiment, the leading end surface 295 of the second pad part 262 is entirely the tapered surface; however, in the cross section in the axial direction passing through the second pad part, at least the end part on the outer side (the outer side in the radial direction) of the leading end surface of the second pad part may be a tapered surface with an axial distance from the reference surface made shorter toward the outer side (the outer side in the radial direction), and the surface of the first pad part may not entirely be the tapered surface.

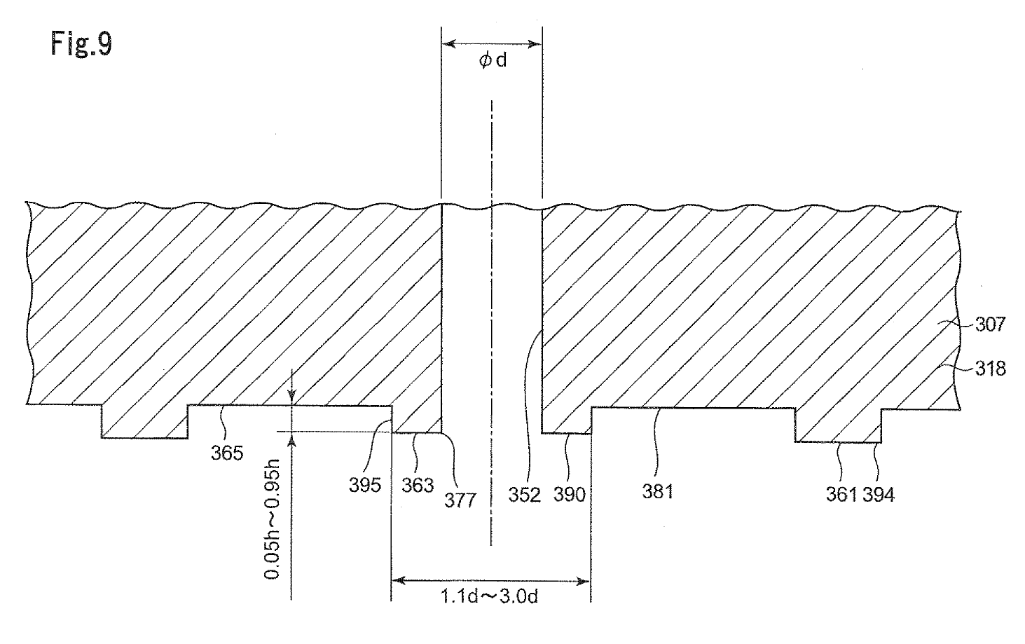

FIG. 9 is a portion of a schematic cross-sectional view in the axial direction of a shoe 307 of a third embodiment and is a portion of a schematic cross-sectional view showing a vicinity of an opening 377 of a lubricant supply hole 352 of a sliding end part 318. In the third embodiment, the same actions, effects, and modification examples as the first embodiment will not be described.

The shoe 307 of the third embodiment has a seal part and a second pad part not shown as well as a first pad part 361 and additionally has a cavitation suppression part 363. The cavitation suppression part 363 has an annular structure and has a cross section in the axial direction formed into a rectangular shape. A leading end surface 390 of the cavitation suppression part 363 is parallel to a reference surface 365 that is a plane surface. A normal direction of the leading end surface 390 of the cavitation suppression part 363 is identical to the axial direction of the shoe 307.

As shown in FIG. 9, the cavitation suppression part 363 protrudes from the reference surface 365 in the axial direction. The cavitation suppression part 363 surrounds the opening 377 of the lubricant supply hole 352 at an interval in the radial direction from the first pad part 361. The cavitation suppression part 363 is located on the inner side (the inner side in the radial direction) relative to the first pad part 361. An annular groove 381 is present between the cavitation suppression part 363 and the first pad part 361 in the radial direction.

The inner circumferential surface of the cavitation suppression part 363 forms a portion of the inner circumferential surface of the lubricant supply hole 352. The cavitation suppression part 363 is located on the piston mounting part side in the axial direction relative to the first pad part 361. A dimension in the radial direction of the cavitation suppression part 363 is shorter than a dimension in the radial direction of the first pad part 361.

In this embodiment, a hole diameter of the lubricant supply hole 352 denoted by pd in FIG. 9 can be a value within a range of 0.5 to 3.0 mm, for example. In an example, an outer diameter of an outer side surface 395 of the cavitation suppression part 363 can be 1.1 to 3.0 times as large as the hole diameter of the lubricant supply hole 352. When h is a distance from the reference surface 365 to a leading end surface of the seal part not shown, an axial distance between the reference surface 365 and the leading end surface 390 of the cavitation suppression part 363 is set to 0.05 h to 0.95 h.

In this embodiment, various dimensions are specified in this way to narrow down an amount of jetted hydraulic oil so as to efficiently suppress the generation of cavitation while suppressing the clogging of metal abrasion powder in the lubricant supply hole 352 at the same time. However, these values are examples and the various dimensions may obviously be set to other than the above.

According to the third embodiment, since the cavitation suppression part 363 having the height from the reference surface 365 lower than that of the first pad part 361 is present in a region closer to the opening 377 on the inner side (the inside in the radial direction) relative to the first pad part 361, a space around the opening 377 can be reduced to suppress the generation of low pressure easily generated around the opening. Therefore, the generation of cavitation can be suppressed and the damage can be suppressed. By forming the cavitation suppression part 363 to bring the hole opening 377 of the lubricant supply hole 352 closer to the sliding surface of the swashplate, the generation of cavitation can significantly be suppressed.

In the third embodiment, the inner circumferential surface of the cavitation suppression part 363 forms a portion of the inner circumferential surface of the lubricant supply hole 352. However, in the present invention, the inner circumferential surface of the cavitation suppression part may not form a portion of the inner circumferential surface of the lubricant supply hole, and a cavitation suppression surface may be located on the inner side in the radial direction of the first pad part. It is noted that the cavitation suppression part is preferably connected to an edge part of the opening of the lubricant supply hole since the generation of cavitation can efficiently be suppressed.

In the third embodiment, the leading end surface 390 of the cavitation suppression part 363 is located on the piston mounting part side in the axial direction relative to the leading end surface 394 of the first pad part 361. However, in the present invention, the leading end surface of the cavitation suppression part may be located on the piston mounting part side in the axial direction relative to the leading end surface of the seal part and may be located on the side opposite to the piston mounting part in the axial direction relative to the leading end surface of the first pad part. In the third embodiment, the dimension in the radial direction of the cavitation suppression part 363 is shorter than the dimension in the radial direction of the first pad part 361, the dimension in the radial direction of the cavitation suppression part may be the same as the dimension in the radial direction of the first pad part, or the dimension in the radial direction of the cavitation suppression part may be longer than the dimension in the radial direction of the first pad part.

Out of ail the embodiments and all the modification examples described above, two or more configurations can obviously be combined to achieve a shoe and a hydraulic rotary device of further embodiments.

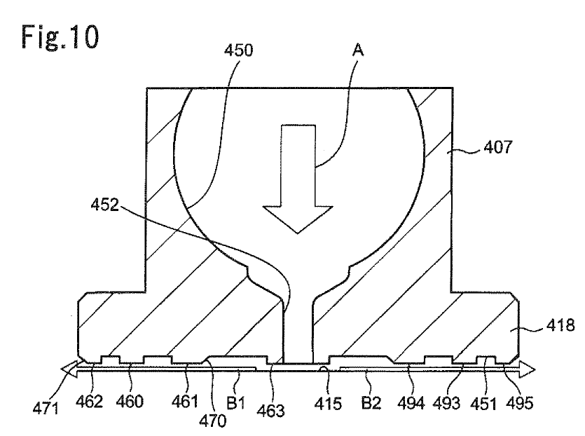

For example, FIG. 10 is a schematic cross-sectional view in the axial direction of an example of such a shoe 407.

As shown in FIG. 10, a sliding end part 418 of this shoe 407 has a seal part 460, a first pad part 461, a second pad part 462, and a cavitation suppression part 463, which are arranged from the inside to the outside in the radial direction in order of the cavitation suppression part 463, the first pad part 461, the seal part 460, and the second pad part 462. An annular groove is present between radially adjacent surfaces. The first pad part 461 and the second pad part 462 are both located on the piston mounting part 450 side in the axial direction relative to the seal part 460, and the cavitation suppression part 463 is located on the piston mounting part 450 side in the axial direction relative to the first pad part 461.

As shown in FIG. 10, in a cross section in the axial direction of the shoe 407, the first pad part 461 has a tapered surface 470 with an axial distance from a leading end surface 493 of the seal part 460 made longer toward the inner side (the inner side in the radial direction) at an end part on the inner side in the radial direction of a leading end surface 494 of the first pad part 461. In a cross section in the axial direction of the shoe 407, the second pad part 462 has a tapered surface 471 with an axial distance from the leading end surface 493 of the seal part 460 made longer toward the outer side (the outer side in the radial direction) at an end part on the outer side in the radial direction of a leading end surface 495 of the second pad part 462.

Because of the configuration described above, the shoe 407 of this embodiment can allow an appropriate amount of the hydraulic oil indicated by an arrow A from the valve plate side through the lubricant supply hole 452 to flow to the outer side (the outer side in the radial direction) indicated by arrows B1 and B2 between an end surface 451 of the sliding end part 418 and a sliding surface 415 of the swashplate and therefore can suppress the cavitation, the volumetric loss, and the mechanical loss.

### EXPLANATIONS OF REFERENCE OR NUMERALS

6 swashplate
7, 107, 207, 307, 407 shoe
15, 415 sliding surface
52, 352, 452 lubricant supply hole
55 mounting recess part
60, 260, 460 seal part
61, 261, 361, 461 first pad part
62, 262, 462 second pad part
65, 265, 365 reference surface
71 annular groove
72 annular groove
75 first lubricant outflow groove
76 second lubricant outflow groove
77, 377 opening of lubricant supply hole
363, 463 cavitation suppression part
381 annular groove
450 piston mounting part
470 tapered surface of first pad part
471 tapered surface of second pad part

1. A shoe for a hydraulic rotary device comprising:
a piston mounting part for attaching a piston;
a sliding end part including a portion sliding on a slide-receiving surface; and
a lubricant supply hole allowing communication between a mounting surface of the piston mounting part and an end surface of the sliding end part,
the sliding end part including;
a substantially planar reference surface,
an annular seal part protruding from the reference surface and located to surround an opening of the lubricant supply hole, the annular seal part sliding on the slide-receiving surface,
a first pad part protruding from the reference surface to a height in an axial direction from the reference surface lower than a height in the axial direction of the seal part from the reference surface, the first pad part being located on the same circumference to entirely or partially surround the opening and facing an inner side surface of the seal part via an annular groove present on an inner side in a radial direction of the seal part, and
a second pad part protruding from the reference surface to a height in the axial direction from the reference surface lower than the height of the seal part, the second pad part being located on the same circumference to entirely or partially surround the opening and facing an outer side surface of the seal part via an annular groove present on an outer side in the radial direction of the seal part.

2. The shoe for a hydraulic rotary device according to claim 1, wherein
the sliding end part includes at least one of a first lubricant outflow groove crossing through the first pad part in the radial direction and allowing lubricant to outflow to the outer side in the radial direction and a second lubricant outflow groove crossing through the second pad part in the radial direction and allowing lubricant to outflow to the outer side in the radial direction.

3. The shoe for a hydraulic rotary device according to claim 1,
in a cross section in the axial direction passing through the first pad part, an inner end part of a leading end surface of the first pad part is a tapered surface with a height in the axial direction from the reference surface made lower toward an inner side.

4. The shoe for a hydraulic rotary device according to claim 1,
in a cross section in the axial direction passing through the second pad part, an outer end part of a leading end surface of the second pad part is a tapered surface with a height in the axial direction from the reference surface made lower toward an outer side.

5. The shoe for a hydraulic rotary device according to claim 1,
the sliding end part includes a cavitation suppression part that protrudes from the reference surface to a height in the axial direction from the reference surface lower than the height of the seal part, that is located on the same circumference to entirely surround the opening, and that faces an inner side surface of the first pad part via an annular groove present on an inner side of the first pad part.

6. A hydraulic rotary device comprising: the shoe for a hydraulic rotary device according to claim 1.
